(19) United States
(12) Patent Application Publication
(10) Pub. No.: US 2007/0031063 A1
(43) Pub. Date: Feb. 8, 2007

(54) Method and apparatus for generating a composite image from a set of images

(76) Inventor: Hui Zhou, Toronto (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/198,715

(22) Filed: Aug. 5, 2005

(51) Int. Cl. G06K 9/36; G06K 9/32

(52) U.S. Cl. 382/284; 382/294

(57) ABSTRACT

A method and apparatus for generating a composite image from a set of images is provided. A reference image is selected from said set. The remaining images in the set are registered to the reference image either directly or through intermediate images that have been previously-registered. The registration of images through previously-registered intermediate images is at least partially based on the length of a shortest path from the images to the reference image through the previously-registered images. The remaining images to the reference image are mapped thereby to generate the composite image.

### FIELD OF THE INVENTION

The present invention relates generally to image processing and in particular, to a method and apparatus for generating a composite image from a set of images.

### BACKGROUND OF THE INVENTION

Generating panoramic or composite images from a set of still images or a sequence of video frames (collectively “images”) is known. In this manner, information relating to the same physical scene at a plurality of different time instants, viewpoints, fields of view, resolutions, and the like from the set of images is melded to form a single wider angle image.

To generate a composite image, the various images are geometrically and calorimetrically registered, aligned and then merged or stitched together to form a view of the scene as a single coherent image. During registration, each image is analyzed to determine if it can be matched with previous images. A displacement field that represents the offset between the images is determined and then the image is warped to the others to remove or minimize the offset.

In order for the composite image to be coherent, points in the composite image must be in one-to-one correspondence with points in the scene. Accordingly, given a reference coordinate system on a surface to which the images are warped and combined, it is necessary to determine the exact spatial mapping between points in the reference coordinate system and pixels of each image.

Many techniques for generating composite images have been considered. For example, U.S. Pat. No. 6,078,701 to Hsu et al. discloses a method of constructing a composite image from a set of images, wherein a topology determination module identifies pairs of images or “neighbors” that spatially overlap. Local coarse registration is used to estimate a low complexity approximate spatial mapping between the neighbors. Final local registration is used to estimate a higher complexity mapping between neighbors or between an image and the current estimate of a mosaic. The registration process is iteratively performed until each image has been registered with another image or only those source images that are unregistrable to other images remain unaligned. A global consistency module infers all of the reference-to-image mappings by simultaneously optimizing all of the mappings such that they are maximally consistent with all of the location registration information and with a chosen reference surface shape (e.g., planar or spherical). Once the images are aligned, a color matching/blending module combines the images to form the composite image.

U.S. Pat. No. 5,325,449 to Burt et al. discloses a method of constructing a composite image from a set of images wherein each image is decomposed into a number of modified images. The decomposed modified images are analyzed using unidirectionally sensitive operators to generate a set of oriented basis functions characteristic of the information content of the original images. The oriented basis functions for the composite image are then selected to construct the composite image.

U.S. Pat. No. 6,075,905 to Herman et al. discloses a method of constructing a composite image from a set of images. The images are selected from a pool of images. The images are first combined to form submosaics. The submosaics are then combined to form a composite image. During the formation of submosaics, the selected images are aligned with one another by determining a geometric transformation, or “warping”, which, after application to all of the selected images, brings the images into a common coordinate system. An alignment error is calculated for each pair of images that overlap. The alignment error is set equal to the calculated sum of the squares of the differences in image intensities in the overlapping area. The alignment error is used to provide a measure of alignment for purposes of adjusting the alignment between the images. The alignment process can be iteratively performed until a desired level of matching between the images is achieved. Subregions of the overlapping aligned images are then selected for inclusion in the composite image. During the selection of the subregions, appropriate cut lines between neighboring images are found based on location, either manually or automatically. Alternatively, the overlapping regions can be averaged or fused together. Each of the remaining portions of the images are then enhanced to improve sharpness or contrast, or to adjust their characteristics to be similar to neighboring images in some other way. The images are then merged together. During merging, feathering, multi-resolution merging, averaging and fusion are used to reduce any visible seams between the images. The raw composite image is then warped to a new coordinate system as desired. This process is then repeated to combine the submosaics into the composite image.

U.S. Pat. No. 6,381,376 to Toyoda discloses an image processing device that includes an intermediate processing section for appending identification data to each pixel, and a matching data generating section for generating matching data for each pixel. The identification data shows the kind of region to which each pixel belongs. The identification data is based on multi-value image data of a plurality of source images entered from a scanner. A processor classifies the kind of region to which each source image belongs based on the identification data of each pixel stored into an identification data memory by means of a connection processing section. The matching data stored in a matching data memory is compared after being processed adequately depending on the kind of region. The processor then extracts matching points of the source images and connects the binary image data of the source images using the extracted matching points as reference points. Consequently, a plurality of source images can be restored to a single image by being connected accurately whether the source images are picture, shadow, or background images.

U.S. Pat. No. 6,522,787 to Kumar et al. discloses a system for imaging a three-dimensional scene to generate a plurality of images and then image process the plurality of images. The image processing includes retrieving the plurality of source images from memory or directly from an image source, combining the images into a mosaic image, selecting a new viewpoint of the scene, and rendering a synthetic image of the scene from that new viewpoint. The synthetic image is then combined with a second image. The combination of the second image and the synthetic image generates a composite image containing a realistic combination of the two images.

U.S. Patent Application Publication No. 2003/0234866 to Cutler discloses a method of calibrating digital omni-directional cameras and a context-specific method of stitching images together into a composite image. Each of the images is corrected for radial distortion. Each image is then mapped to a cylindrical coordinate system. Translation, scaling and rotation are then used to align each image with neighboring images. The images are then stitched into a composite image by either blending overlapping regions or by using context-sensitive stitching.

U.S. Patent Application Publication No. 2004/0056966 to Schechner et al. discloses a method of generating enhanced-resolution data. A camera is rotated in order to capture images of different portions of a target. The camera can have imaging sensitivity characteristics that are non-uniform across the viewing angle of the camera. The imaging sensitivity characteristics can include exposure, color sensitivity, polarization sensitivity, focal distance and any other aspect of image detection. As the camera is translated between image captures, each portion of the target is captured by multiple portions of the camera's sensitivity profile.

U.S. Patent Application Publication No. 2004/0076340 to Neilson discloses a method of constructing a composite image using a plurality of cameras. Corresponding points in images are searched based on an error between light beam vectors projected on a projection plane without performing a comparison between pixel values at the corresponding points. As original picked-up images are pasted directly to an output composite image based on errors between light beam vectors without transforming any picked-up images once placed in the composite image, deterioration of pixels can be suppressed.

U.S. Patent Application Publication No. 2004/0169870 to Ahmed et al. discloses a method of constructing a composite image and performing image enhancement thereon. Images are acquired using a set of imaging elements. Some of the imaging elements have overlapping or rotated fields of view. The images are combined to construct a composite image. During construction of the composite image, features are extracted from overlapping regions of the images and matched. The features can be edges. Alternatively, the recombination can be performed by positioning each image with respect to a larger image through image matching and location techniques.

U.S. Patent Application Publication No. 2004/0175055 to Miller et al. discloses a method of constructing a high-resolution composite image from a plurality of time-sequential high-resolution images. Low-resolution images are generated from the time-sequential high-resolution images. The pixels from the low-resolution images are then combined to construct a high-resolution composite image.

Although the above references disclose methods of generating a composite image, there exists a need to improve the generation of such composite images. It is therefore an object of the present invention to provide a novel method and apparatus for generating composite images from a set of images.

### SUMMARY OF THE INVENTION

Accordingly, in one aspect there is provided a method of generating a composite image from a set of images, comprising:

selecting a reference image from said set;

registering remaining images in said set to said reference image either directly or through intermediate images that have been previously-registered, registration of images through previously-registered intermediate images being at least partially based on the length of a shortest path from said images to said reference image through said previously-registered images; and

mapping the registered images to said reference image thereby to generate said composite image.

In one embodiment, the length of the shortest path is measured by determining the number of images traversed along the shortest path. The remaining images are selected for registration in cycles. During each cycle, images are selected for registration in stages. During a first stage of an initial registration cycle, images adjacent the reference image along vertical or horizontal paths are selected and registered to the reference image. During each subsequent stage S of the initial registration cycle, images separated from the reference image by S-1 number of previously-registered images along a registration path including only horizontal and vertical components are selected and registered. Upon completion of the initial registration cycle, if unregistered images exist, additional registration cycles are performed to register the unregistered images with adjacent previously-registered images. The additional registration cycles are performed until each of the unregistered images is registered or is deemed unregistrable.

According to another aspect, there is provided a method of generating a composite image from a set of images, one of the images in said set being designated a reference image, said method comprising:

selecting images adjacent to the reference image that are unregistered with said reference image;

analyzing the selected images to determine whether said selected images can be registered directly with said reference image and registering those selected images with said reference image;

selecting other images that are unregistered with said reference image;

analyzing the selected other images to determine whether said selected other images can be registered with previously-registered images and registering those selected other images with said reference image; and

repeating the selecting, analyzing and registering until each of said images is either registered or deemed unregistrable.

According to yet another aspect, there is provided a a method of generating a composite image from a set of images, comprising:

selecting a reference image from said set;

iteratively determining whether the other images in said set can be registered with said reference image or with adjacent images that have been previously-registered to said reference image and registering those images; and

transforming the registered images to the reference image.

According to still yet another aspect, there is provided an apparatus for generating a composite image from a set of images, comprising:

a registrar selecting a reference image from said set and registering remaining images in said set to said reference image either directly or through intermediate images that have been previously-registered, registration of images through previously-registered intermediate images being at least partially based on the length of a shortest path from said images to said reference image through said previously-registered images; and

an image transformer mapping the registered images to said reference image thereby to generate said composite image.

According to still yet another aspect, there is provided an apparatus for generating a composite image from a set of images, one of the images in said set being designated a reference image, said method comprising:

means for selecting images adjacent to the reference image that are unregistered with said reference image;

means for analyzing the selected images to determine whether said selected images can be registered directly with said reference image and registering those selected images with said reference image;

means for selecting other images that are unregistered with said reference image;

means for analyzing the selected other images to determine whether said selected other images can be registered with previously-registered images and registering those selected other images with said reference image; and

means for repeating the selecting, analyzing and registering until each of said images is either registered or deemed unregistrable.

According to still yet another aspect, there is provided a computer readable medium embodying a computer program for generating a composite image from a set of images, said computer program comprising:

computer program code for selecting a reference image from said set;

computer program code for registering remaining images in said set to said reference image either directly or through intermediate images that have been previously-registered, registration of images through previously-registered intermediate images being at least partially based on the length of a shortest path from said images to said reference image through said previously-registered images; and

computer program code for mapping the registered images to said reference image thereby to generate said composite image.

According to still yet another aspect, there is provided a computer readable medium embodying a computer program for generating a composite image from a set of images, said computer program comprising:

computer program code for selecting a reference image from said set;

computer program code for iteratively determining whether the other images in said set can be registered with said reference image or with adjacent images that have been previously-registered to said reference image and registering those images; and

computer program code for transforming the registered images to the reference image.

By iteratively attempting to register unregistered images in priority at least partially based on the length of a shortest path from an unregistered image to a reference image through previously-registered images, the registration path can be reduced.

### BRIEF DESCRIPTION OF THE DRAWINGS

Embodiments will now be described more fully with reference to the accompanying drawings in which:

FIG. 1 illustrates an exemplary set of images used to generate of a composite image;

FIG. 2 shows a schematic representation of a computing device for generating a composite image;

FIG. 3 is a flowchart showing the general steps performed during composite image generation;

FIG. 4 shows a first registration cycle stage for the images of FIG. 1;

FIG. 5 is a flowchart showing the steps performed during registration between two images;

FIG. 6 shows a second registration cycle stage for the images of FIG. 1;

FIG. 7 is a flowchart showing the steps performed during registration of an image with two adjacent images;

FIGS. 8A to 8D illustrate registration graphs;

FIG. 9 is a flowchart showing the steps performed during transformation of the images;

FIG. 10 illustrates transformation adjustment for an image;

FIG. 11 illustrates the final positions of the images after transformation; and

FIGS. 12A to 12F illustrate registration cycles for a larger set of images.

### DETAILED DESCRIPTION OF THE EMBODIMENTS

In the following description, an embodiment of a method, apparatus for generating a composite image from a set of images is provided. During the method a reference image from the set is selected. Remaining images in the set are registered to the reference image either directly or through intermediate images that have been previously-registered. Registration of images through previously-registered intermediate images is at least partially based on the length of a shortest path from the images to the reference image through the previously-registered images. The registered images are then mapped to the reference image thereby to generate the composite image.

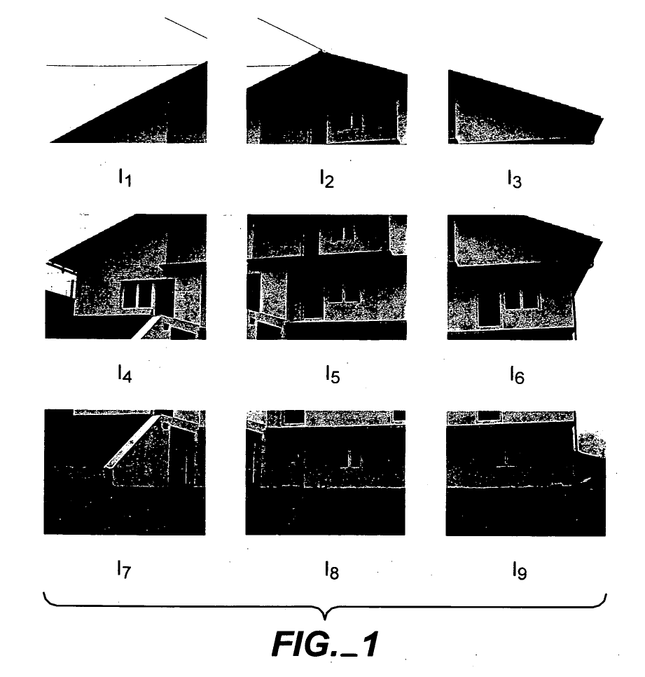

FIG. 1 illustrates an exemplary set of images that may be combined to generate a composite image. In this example, the images are of different sections of a house with each adjacent pair of images sharing a common image area; that is, they overlap. By aligning the images to one another and then stitching them to each other, a composite image of the entire house can be generated.

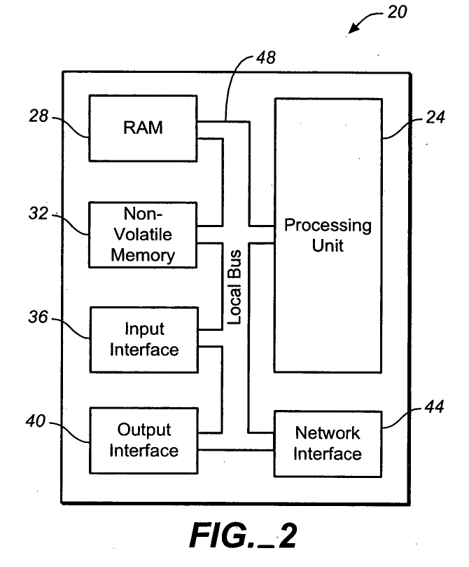

Turning now to FIG. 2, a computing device 20 for generating a composite image from a set of images is shown. As can be seen, the computing device 20 comprises a processing unit 24, random access memory (“RAM”) 28, non-volatile memory 32, an input interface 36, an output interface 40 and a network interface 44, all in communication over a local bus 48. The processing unit 24 retrieves a composite image generation application for generating composite images from the non-volatile memory 32 into the RAM 28 for execution. The non-volatile memory 32 can store images from which a composite image is to be generated, and can also store the generated composite image itself. The input interface 36 includes a keyboard and mouse, and can also include a communications or video interface for receiving images. The output interface 40 can include a display for presenting information to a user of the computing device 20 to allow interaction with the composite image generation application. The network interface 44 allows video frames and composite images to be sent and received via a communication network to which the computing device 20 is coupled.

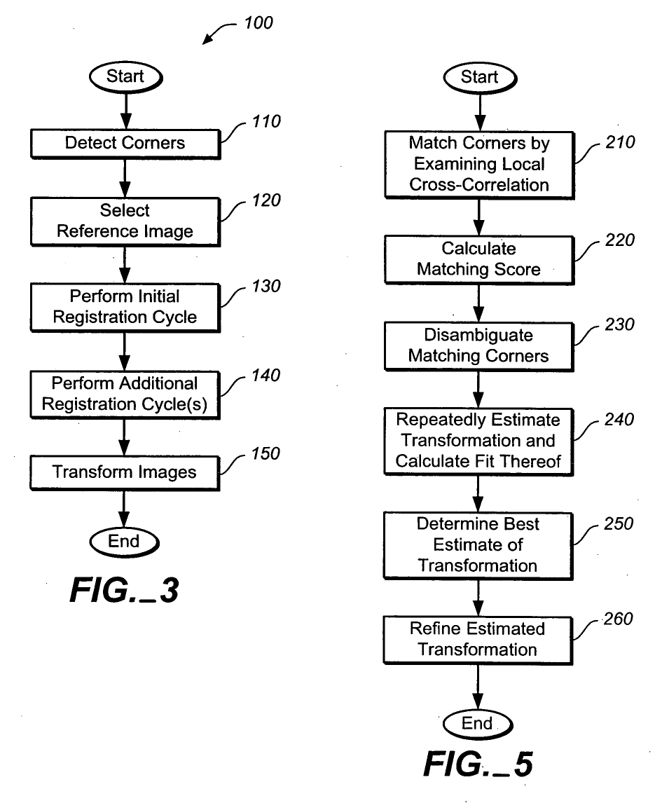

FIG. 3 illustrates the general method 100 of generating a composite image from a set of images that is arranged in an array of m rows and n columns. Initially, the images in the array are converted to grayscale and the grayscale images are examined to detect corners therein using a corner detection algorithm (step 110). Corners are defined as changes in direction along contours of at least a pre-determined angle. Once the corners within each of the images have been detected, a reference image is selected from the set of images (step 120). In this example, the most central image within the array is automatically selected as the reference image. This is done to reduce the maximum distance between the reference image and any other image within the array.

With the reference image selected, an initial registration cycle is performed in an attempt to register all of the other images in the array to the reference image (step 130). As the images in the set are arranged in rows and columns, they form concentric rings around the reference image. During initial registration, images surrounding the reference image are selected in a series of stages according to the rings in which the images are located, and the distance the images are from the reference image in either vertical or horizontal steps or paths. Initially, in the first stage of the registration cycle, images in the first or closest ring to the reference image that are above, below and on opposite sides of the reference image are selected i.e. those images that are one horizontal or vertical step from the reference image, and an attempt is made to register these images to the reference image. Next in the second stage of the initial registration cycle, images in the first ring that are two horizontal or vertical steps from the reference image are selected and an attempt is made to register these images to the reference image. After the images in the first ring have been processed, images in any remaining rings of the set, if they exist, are processed in subsequent stages in a similar manner to register these images to adjacent previously-registered images thereby to complete the initial registration cycle. Following completion of the initial registration cycle, a check is made to determine if any images remain unregistered to the reference image. If such unregistered images exist, additional registration cycles are performed in an attempt to register these images to the reference image. The additional registration cycles continue until each unregistered image either has been registered to an adjacent previously-registered image or is deemed to be unregistrable.

FIG. 4 illustrates the first stage of the initial registration cycle for the set of images of FIG. 1. In this example, image I₅ is the reference image as it is the centrally located image in the set. During the first stage of the initial registration cycle, the four images I₂, I₈, I₄, I₆ adjacent the top, bottom, left and right of the reference image I₅ are selected for registration with the reference image as they are in the first ring of images that surrounds the reference image I₅ and are either one vertical or horizontal step from the reference image.

Once the first series of images from the set have been selected, an attempt is made to register each of the selected images to the reference image I₅. FIG. 5 shows the steps performed when registering a pair of adjacent images. Initially, a local neighborhood cross-correlation is performed to match the corners within the adjacent images (step 210). A matching score is calculated by determining the shift and rotation consistency within the neighborhoods of each corner (step 220). Next, corners that are not matching one-to-one are disambiguated by relaxing the matching constraints (step 230). The transformation between the adjacent images is estimated a pre-defined number of times and the resulting image fits are calculated (step 240). To estimate each transformation, four pairs of corners are randomly chosen from the images and are used to solve a set of eight linear equations. Each estimated transformation is then applied to all of the matching pairs of corners in the images and the number of corner pairs in the images that yield a similar transformation is determined thereby to determine an image fit. The estimated transformation that yields the best fit is then selected (step 250) and the selected transformation is refined (step 260). During refining, other matching corners in the images that are supported by the selected transformation are combined to form a set of over-constrained linear equations. These linear equations are then solved to refine the selected transformation.

During the above first stage of the registration cycle, it is possible that one or more of the images in the first series cannot be registered directly with the reference image. An image is deemed to be unregistrable to the reference image if the number of corners that support the selected transformation is less than a pre-defined value.

Once the first stage of the registration cycle is completed, the second stage of the registration cycle is performed. In this case, the remaining images in the first ring that are two horizontal or vertical steps from the reference image are selected. FIG. 6 illustrates selection of the images during the second stage of the registration cycle for the set of images of FIG. 1. For this stage, each selected image can be mapped to the reference image along two registration paths of equal length through one intermediate image. For example, looking at image I₁, this image can be mapped to the reference image either through image I₂ or image I₄; that is:
1→2→5; and
1→4→5.
Once the images have been selected, each selected image is registered simultaneously to the intermediate images that map the selected image to the reference image provided the intermediate images were successfully registered to the reference image. Registering each selected image with both intermediate images allows a shortest registration path between the image and the reference image to be determined.

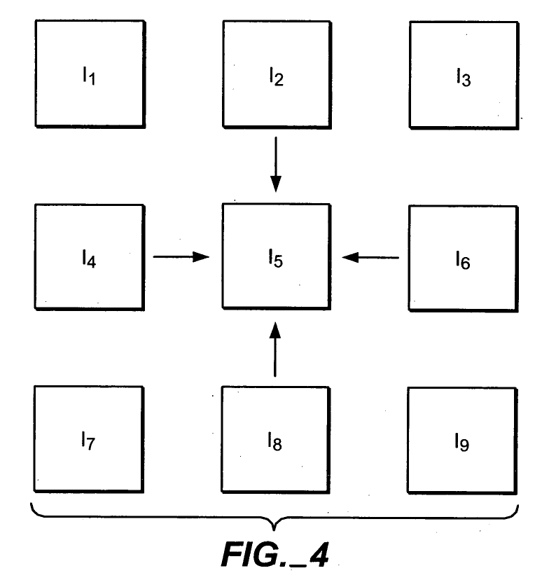

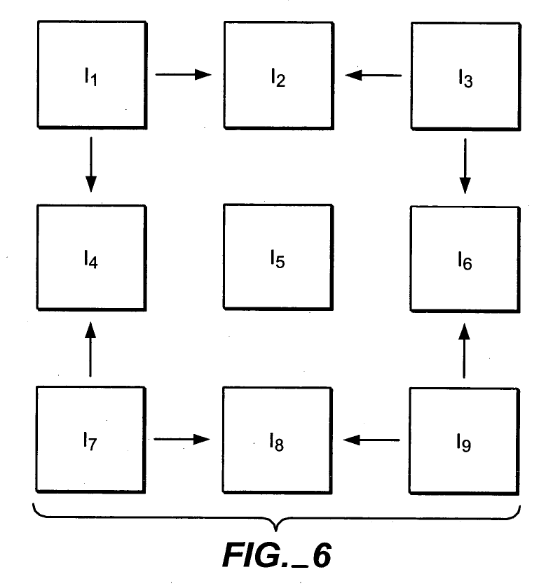

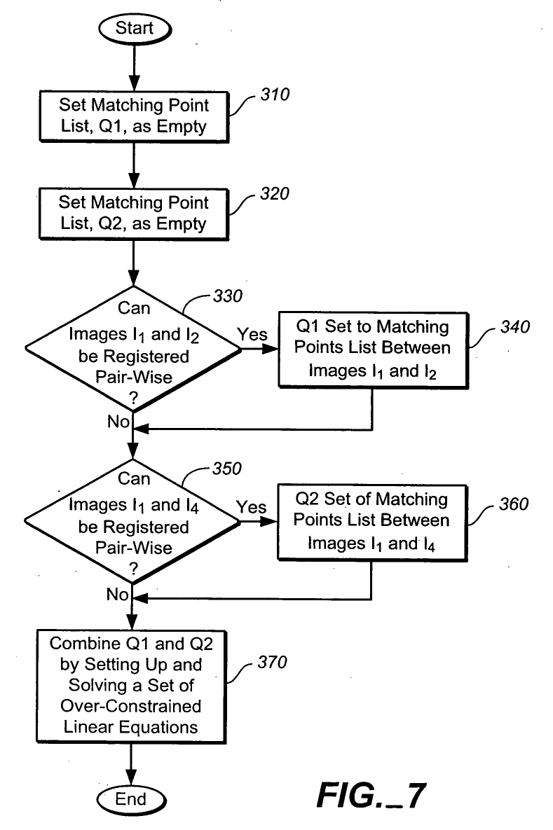

FIG. 7 shows the steps performed in order to register an image selected during the second stage of the registration cycle to two previously-registered intermediate images simultaneously. For ease of reference, registration of image I₁ with intermediate images I₂ and I₄ will be described. Those of skill in the art will however appreciate that this discussion applies equally to the other images selected during the second stage of the registration cycle. During the method, a matching points list, Q1, for corners in images I₁ and I₂ is initially set as empty (step 310). A matching points list, Q2, for corners in images I₁ and I₄ is also set as empty (step 320). It is then determined whether images I₁ and I₂ can be registered pair-wise to one another (step 330). Registration of images I₁ and I₂ is performed in the manner previously described with reference to FIG. 5. If images I₁ and I₂ can be registered pair-wise to one another, the matching points between the images I₁ and I₂ is used to populate the list Q1 (step 340). It is then determined whether images I₁ and I₄ can be registered pair-wise to one another (step 350). Again, registration of images I₁ and I₄ is performed in the manner previously described with reference to FIG. 5. If images I₁ and I₄ can be registered pair-wise, the matching points between the images I₁ and I₄ is used to populate the list Q2 (step 360). The matching points lists, Q1 and Q2, are then combined by setting up and solving a set of over-constrained linear equations thereby to yield registration information for the image I₁ (step 370). By registering the image I₁ to two neighbor images that have successfully been registered to the reference image, additional information regarding the position of image I₁ relative to the adjacent images that helps to avoid misalignment errors is obtained.

As the registration of images to the reference image is performed stage-by-stage, a registration graph can be constructed showing the registration information between images. The registration graph is a direct graph representation of the composite image, wherein each image is represented by a node in the graph and adjoining edges of images are represented by links joining the nodes.

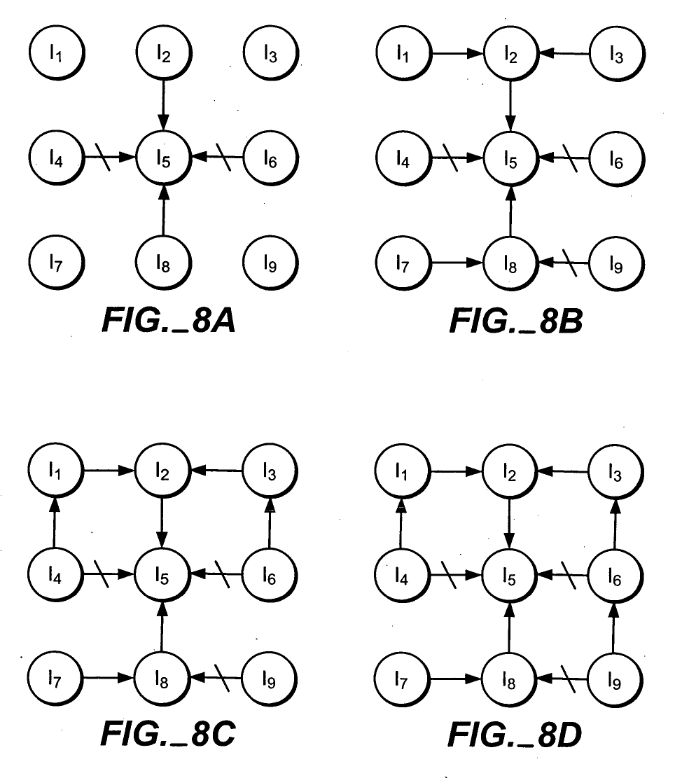

FIGS. 8A to 8D show an exemplary registration graph during various stages of the initial registration cycle for the images of the set of FIG. 1. In particular, FIG. 8A illustrates the registration graph after the first stage of the initial registration cycle. In this example, the registration graph shows that images I₂ and I₈ have been registered to the reference image I₅. The registration graph also shows that images I₄ and I₆, were not successfully registered to the reference image I₅.

FIG. 8B illustrates the registration graph after completion of the second stage of the initial registration cycle. As can be seen, the registration graph shows that images I₁ and I₃ have been successfully registered to previously-registered image I₂ only. Similarly, the registration graph shows that image I₇ has been successfully registered to previously-registered image I₈ only. Image I₉ is shown as being unregistrable with image I₈, its only neighbor that is registered to reference image I₅. As will be noted, no attempt has been made to register images I₁ and I₇ to image I₄ as image I₄ was not previously-registered to the reference image I₅. Similarly, no attempt has been made to register images I₃ and I₉ to image I₆ as image I₆ was not previously-registered to the reference image I₅.

As noted in the example above, after completion of the first and second stages of the initial registration cycle, not all of the images in the ring have been successfully registered to the reference image or to a previously-registered image. In this case, additional registration cycles are performed, in an attempt to register the unregistered images to an image that has been successfully registered to the reference image. During these additional registration cycles, it is desired to register the unregistered images to previously-registered images that map the unregistered image to the reference image through the shortest registration path i.e. the path with smallest number of horizontal and vertical steps.

During the additional registration cycles at step 140, each image that was not registered during the initial registration cycle is analyzed in the same order used during the initial registration cycle. That is, during each additional registration cycle, the remaining unregistered images are analyzed in a series of stages according to the rings in which the unregistered images are located, and the distance the unregistered images are from the reference image in either vertical or horizontal steps. This order is at least partially based on the length of the shortest path from the unregistered images to the reference image through the previously-registered images. In this manner, unregistered images closer to the reference image that are successfully registered to previously-registered images can potentially form part of a registration path for other further unregistered images. Further, all potential registration paths of a certain length are explored when trying to register an unregistered image before trying to register the image along a relatively longer registration path. As a result, the registration path determined for each image is the shortest possible.

The Floyd-Warshall All-Pairs Shortest Path algorithm is used to determine the shortest registration path between each unregistered image and the reference image in the registration graph. Each link between nodes representing a registration between two images is assigned a cost of 1, whereas links between nodes representing a pair of images that could not be registered to one another is assigned a cost of large magnitude to effectively bar use thereof. A link between two nodes v and w is represented by (v,w) and the cost of the link is represented by C[v,w].

The Floyd-Warshall algorithm generates two matrices as output, namely a distance matrix D[v,w] that contains the cost of the lowest cost registration path from node v to node w, and a path matrix P[v, w] that identifies the intermediate node, k, on the least cost registration path between v and w that led to the cost stored in D[v,w]. Initially, D[v,w]=C[v,w]. N iterations over the matrix D, using k as an index, are performed. On the k^{th} iteration, the matrix D provides the solution to the shortest registration path problem, where the registration paths only use nodes numbered 1 . . . k. On the next iteration, the cost of the registration path from i to j using only nodes numbered 1 . . . k (stored in D[i,j] on the k^{th} iteration) with the cost of using a (k+1)^{th} node as an intermediate step is calculated, which is D[ik+1] (to get from i to k+1) plus D[k+1,j] (to get from k+1 to j). If this results in a lower cost registration path, it is recorded. After N iterations, all possible registration paths are examined with D[v,w] containing the cost of the lowest cost registration path from v to w using all nodes if necessary.

The matrix P for each pair of nodes u and v, contains an intermediate node on the least cost registration path from u to v. The least cost registration path from u to v is the least cost registration path from u to P[u,v], followed by the least cost registration path from P[u,v] to v.

After the shortest registration path for an unregistered image is determined together with the adjacent image along that registration path, registration is attempted between the unregistered image and the adjacent image in the manner previously described with reference to FIG. 5. If the registration is successful, the registration graph is updated to include the appropriate link. The additional registration cycles are performed until every image has been successfully registered or there is no way to register unregistered images with adjacent previously-registered images that are mapped to the reference image through intermediate images.

FIG. 8C shows the registration graph of FIG. 8B after completion of the first stage of a first additional registration cycle. While image I₄ was not registrable directly to the reference image I₅, the registration graph shows image I₄ registered to image I₁, which is, in turn, mapped to the reference image I₅ though intermediate image I₂. Similarly, while image I₆ was not directly registrable to reference image I₅, the registration graph shows image I₆ registered to image I₃ which is, in turn, mapped to reference image I₅ through intermediate image I₂. As will be appreciated, at the start of this registration stage image I₉ is not adjacent a registered image and, thus, cannot be registered.

FIG. 8D shows the registration graph after the second stage of the first additional registration cycle. As image I₆ was previously-registered during the first stage of the first additional registration cycle, previously unregistered image I₉ can be and is registered to image I₆ as shown in the registration graph. Upon registration of image I₉, all of the images are registered with reference frame I₅ and are ready for transformation.

In the above illustrated example, only one additional registration cycle is performed as no unregistered images remain thus, completing the registration process. In situations where unregistered images remain, after the first additional registration cycle is performed, additional registration cycles are performed until either all images are registered or until no additional images are registered during the last-performed registration cycle, signifying that remaining unregistered images cannot be registered to an adjacent previously-registered image.

Once the shortest registration paths between each image and the reference image have been determined, the transform matrices for transforming each image to the reference image are determined. The transform matrices represent the transformation of the images from an initial position to their positions relative to the reference image (i.e., the absolute position). The transform matrix for a particular image is equal to the product of the transformation matrices for each link between registered images that are along that image's shortest registration path to the reference image.

Turning to FIG. 9, the steps performed during transformation of the registered images are shown. Initially, the images that are registered directly to the reference image are transformed using the determined transformation (step 410). It is then determined whether there remain any registered images that have not been transformed (step 420). If registered images that have not been transformed exist, a registered image is selected and transformed to align common corners with a previously-transformed image (step 430). This is repeated until all registered images have been transformed.

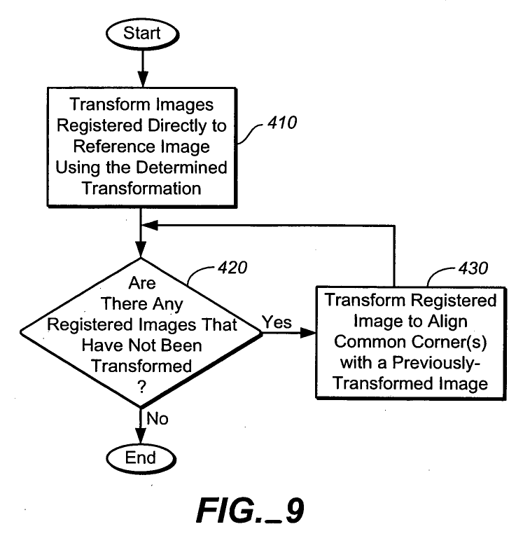

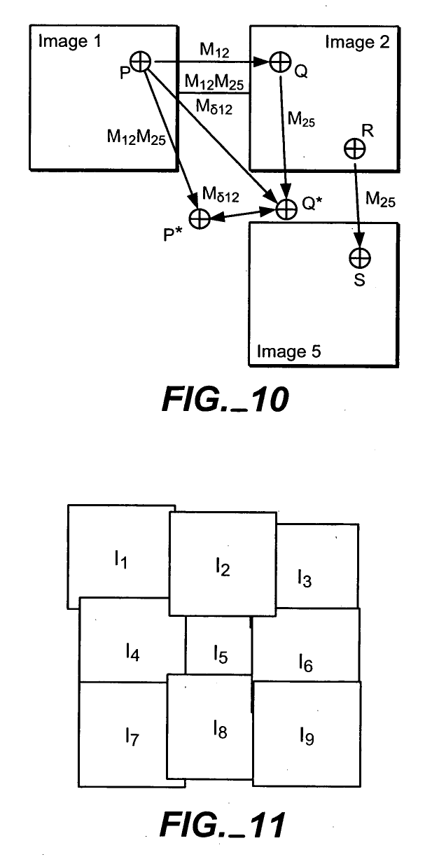

FIG. 10 illustrates the method of FIG. 9 with respect to transformations for images I₁ and I₂ relative to the reference image I₅. During the registration of the images of FIG. 1, image I₂ was registered directly with reference image I₅ and image I₁ was registered to reference image I₅ through previously-registered intermediate image I₂. That is, the shortest registration path from the image I₁ to the reference image I₅ was determined to be:
1→2→5

As image I₂ is directly registrable to reference image I₅, it is transformed during step 410. Image I₂ is shown having a first point R that is translated to point S in reference image I₅ in accordance with the transformation determined during registration. Image I₁, however, is registered to reference image I₅ via previously-registered intermediate image I₂. The transform matrix for transforming the image I₁ to image I₅, M_{[1][5]}, is a product of the transform matrices for transforming the image I₁ to image I₂, and then to image I₅. That is,
M_{[1][5]}=M_{[2][5]}×M_{[1][2]} (1)
Each of the transform matrices M_{[2][5]} and M_{[1][2]} is derived during the determination of the registration of the image I₂ with the image I₅, and the image I₁ with the image I₂.

The transform matrices obtained by multiplying the matrices along the registration path to the reference image may not be accurate. In some cases, a very small error is present in the transform matrix between each pair. Thus:
M_{[1][5]}=\hat{M}_{[1][5]}+M_{δ15}
M_{[2][5]}=\hat{M}_{[2][5]}+M_{δ25}
M_{[1][2]}=\hat{M}_{[1][2]}+M_{δ12}
where, \hat{M}_{[1][5]}, \hat{M}_{[2][5]} and \hat{M}_{[1][2]} are the correct transform matrices and M_{[2][5]} and M_{[1][2]} are the estimated transform matrices between images I₂ and I₅ and images I₁ and I₂ respectively. Accordingly, M_{δ15}, M_{δ25} and M_{δ12} are the corresponding error matrices.

By substituting these values in Equation 1, the cumulative transformation is determined to be:
\hat{M}_{[1][5]}+M_{δ15}=(\hat{M}_{[2][5]}+M_{δ25})(\hat{M}_{[1][2]}+M_{δ12})

As the correct cumulative transform matrix is a product of the correct individual transform matrices, that is, \hat{M}_{[1][5]}=\hat{M}_{[2][5}]\hat{M}_{[1][2}], then
M_{δ15}=\hat{M}_{[1][2}]M_{δ25}+M_{δ12}\hat{M}_{[2][5]}+M_{δ25}M_{δ12}

As a result of the matrix multiplication, the cumulative error, M_{δ15}, may be accumulated and amplified. This cumulative error becomes even larger when the multiplication sequence is longer (which is the case when the registration path is longer). By determining the shortest registration path, the effect of this cumulative error can be reduced. Where there are a large number of columns and/or rows of images, however, the cumulative error can be significantly large.

To reduce the effect of the cumulative error during the transformation of a registered image at step 430, the matching point list along the registration path from the registered image to the reference image is remapped. In the example illustrated in FIG. 10, the image I₁ is registered relative to previously-registered image I₂, which in turn, is registered to the reference image I₅. A point P in image I₁ corresponds to a point Q in image I₂, and point R in image I₂ corresponds to a point S in reference image I₅.

The transform matrices M_{[1][2]} between images I₁ and I₂, and M_{[2][5]} between images I₂ and I₅ are estimated by solving the corresponding matching point lists. A point Q* corresponding to the point Q after having been translated to the reference image using M_{[2][5]} can be calculated. A point P* corresponding to the point P after having been translated to the reference image using M_{[2][5]}×M_{[1][2]} can also be calculated. Points P* and Q* can be translated to locations inside or outside of the reference image I₅.

In theory, P* should be located at the same point as Q*. This is not, however, typically the case. P* can differ from Q* as Q* is calculated from M_{[2][5]}, whereas P* is calculated using M_{[2][5]}×M_{[1][2]}. As noted above, a cumulative error can result from one or more matrix multiplications. As a result, Q* may be more accurate than P*. The transform matrix M_{[1][5]} can then be corrected to \hat{M}_{[1][5]} by determining the transformation between the corners in the overlapping portion of image I₁ and the corresponding translated corners from image I₂, thereby cancelling the additional error present in M_{[1][5]} determined using the multiplied individual transformations. This correction is repeated for all registration paths containing three or more images.

For illustration purposes, assume that, for a path from image I₁ to image I₂ to . . . image I_{N}, image I₁ is to be aligned to image I_{N}. Pᵢ and Pⱼ are coordinates of matched points in images Iᵢ and Iⱼ, respectively. The transform matrix M_{[1][N]} can be adjusted to alleviate the effect of the cumulative error by using the following approach:

Step 1: i←N−2, j←i+1

Step 2: Pⱼ′←M_{[j][N]}Pⱼ

Step 3: Solve M_{[i][N]}Pᵢ=Pⱼ′ to solve M_{[i][N]}

Step 4: i←i−1, j←i+1

Step 5: If i≧1, go to step 2

Step 6: End

During step 2, Pⱼ is transformed relative to the reference image I_{N}. During step 3, the transformation, M_{[j][N]}, to transform image Iᵢ to the reference image I_{N} is redetermined to be equal to the transformation required to transform the point Pᵢ to the transformed position of Pⱼ. In particular, M_{[i][N]} is determined by solving a set of linear equations. Steps 2 to 4 are repeated until i reaches 1, at which point M_{[1][N]} is determined.

Upon alignment to the reference image and the correction of the cumulative error, the positions of all successfully registered images relative to the reference image are known resulting in an estimated transform matrix for each registered image that transforms or maps the image to the reference image.

FIG. 11 illustrates an exemplary composite image generated from the images of FIG. 1, wherein each image has been transformed to an absolute position relative to the reference image. As will be understood, the individual images may, in many cases, be offset from one another when assembled into the composite image.

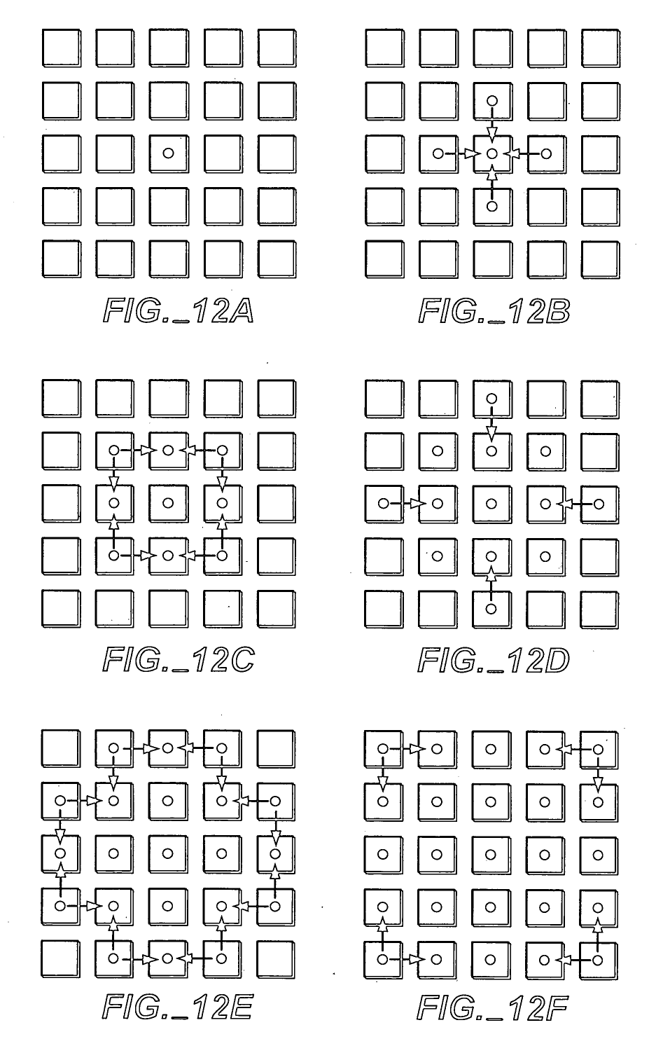

Although the above discussion references a set of images including a single ring of images surrounding the reference image, those of skill in the art will appreciate that images including multiple rings of images surrounding the reference image may be used to form the composite image. For purposes of better illustrating the various stages of the registration cycles, FIGS. 12A to 12F show the images selected during the stages of the initial registration cycle for a set of twenty-five images arranged in five rows and five columns. In FIG. 12A, the centrally located reference image is identified by a dot. In FIG. 12B, the four images in the first ring adjacent the reference image along horizontal and vertical paths that are selected in the first stage of the initial registration cycle are shown by the arrows. In FIG. 12C, the four images selected in the second stage of the initial registration cycle are shown by the arrows.

Once the images in the first ring around the reference image have been selected and registered, images in the second ring around the reference image are selected. In the third stage of the initial registration cycle shown in FIG. 12D, the images in the second ring that have the shortest registration path to the reference image (that is, those directly vertically or horizontally removed from the reference image) are selected as shown by the arrows. In the fourth stage of the initial registration cycle shown in FIG. 12E, the images in the second ring and adjacent the images selected in the previous stage are selected as shown by the arrows. In the fifth stage shown in FIG. 12F, the images in the second ring adjacent the images selected in the previous stage are selected as shown by the arrows thereby to complete the initial registration cycle. If unregistered images exist, the above selection pattern is repeated during additional registration cycles.

Although the above-described embodiment shows the composite image being formed from a set of images forming rectangular rings around the reference image, those of skill in the art will appreciate that the images can be analyzed in other orders. For example, a diamond-shape pattern of analysis can be used.

Other methods of registering one image to one or more adjacent images can also be used. For example, edges in the images can be used to register the images to one another. After registration, a matching list of selected points can be created for the correction of the accumulated errors along the registration path.

While the reference image is described as being automatically selected based on its central location, those of skill in the art will appreciate which other methods for selecting the reference image can be used. For example, where the images are irregularly laid out, a density approach can be used to select the reference image to reduce the number of transformations required to transform the images. Alternatively, the reference image may be manually selected.

Various shortest path algorithms can be employed in place of the Floyd-Warshall All-Pairs Shortest Path algorithm. For example, where there is a large, sparse graph, Dijkstra's algorithm may be used. Other shortest path algorithms will occur to those skilled in the art.

The composite image generation method and apparatus may be embodied in a software application including computer executable instructions executed by a processing unit such as a personal computer or other computing system environment. The software application may run as a stand-alone digital image editing tool or may be incorporated into other available digital image editing applications to provide enhanced functionality to those digital image editing applications. The software application may include program modules including routines, programs, object components, data structures etc. and be embodied as computer readable program code stored on a computer readable medium. The computer readable medium is any data storage device that can store data, which can thereafter be read by a computer system. Examples of computer readable medium include for example read-only memory, random-access memory, CD-ROMs, magnetic tape and optical data storage devices. The computer readable program code can also be distributed over a network including coupled computer systems so that the computer readable program code is stored and executed in a distributed fashion.

Although particular embodiments have been described, those of skill in the art will appreciate that variations and modifications may be made without departing from the spirit and scope thereof as defined by the appended claims.

What is claimed is:

1. A method of generating a composite image from a set of images, comprising:
selecting a reference image from said set;
registering remaining images in said set to said reference image either directly or through intermediate images that have been previously-registered, registration of images through previously-registered intermediate images being at least partially based on the length of a shortest path from said images to said reference image through said previously-registered images; and
mapping the registered images to said reference image thereby to generate said composite image.

2. The method of claim 1, wherein the length of the shortest path is measured by the number of images traversed along said shortest path.

3. The method of claim 2, wherein the remaining images are selected for registration in cycles.

4. The method of claim 3, wherein during each cycle, images are selected for registration in stages.

5. The method of claim 4, wherein during a first stage of an initial registration cycle, images adjacent said reference image along horizontal or vertical paths are selected and registered to said reference image.

6. The method of claim 5, wherein for each subsequent stage S of said initial registration cycle, images separated from the reference image by S-1 number of registered images along a registration path including only horizontal and vertical components are selected and registered.

7. The method of claim 6, wherein upon completion of said initial registration cycle, if unregistered images exist, performing additional registration cycles to register said unregistered images with adjacent previously-registered images.

8. The method of claim 7, wherein said additional registration cycles are performed until each of said unregistered images is registered or is deemed unregistrable.

9. The method of claim 1, wherein said images are generally aligned in rows and columns and wherein said reference image is the centrally located image in said set.

10. The method of claim 9, wherein said images form concentric rings around said reference image, and wherein unregistered images in a first ring are analyzed before unregistered images in a second ring that is larger than said first ring.

11. The method of claim 1, wherein during said mapping, transformation matrices transforming each registered image to said reference image are determined.

12. The method of claim 11, wherein said transformation matices are error corrected.

13. A method of generating a composite image from a set of images, one of the images in said set being designated a reference image, said method comprising:
selecting images adjacent to the reference image that are unregistered with said reference image;
analyzing the selected images to determine whether said selected images can be registered directly with said reference image and registering those selected images with said reference image;
selecting other images that are unregistered with said reference image;
analyzing the selected other images to determine whether said selected other images can be registered with previously-registered images and registering those selected other images with said reference image; and
repeating the selecting, analyzing and registering until each of said images is either registered or deemed unregistrable.

14. The method of claim 13, wherein said other images are selected in priority at least partially based on the length of a shortest path from said selected other images to said reference image through previously-registered images.

15. The method of claim 14, wherein the length of the shortest path is measured by the number of previously-registered images traversed along said shortest path.

16. The method of claim 15, further comprising transforming the registered images to said reference image.

17. The method of claim 16, wherein during said transforming, transformation matrices transforming each registered image to said reference image are determined.

18. The method of claim 17, wherein said transformation matices are error corrected.

19. A method of generating a composite image from a set of images, comprising:
selecting a reference image from said set;
iteratively determining whether the other images in said set can be registered with said reference image or with adjacent images that have been previously-registered to said reference image and registering those images; and
transforming the registered images to the reference image.

20. The method of claim 19, wherein the determining and registering is performed in stages based at least partially on the proximity of the images to the reference image.
